(19) United States
(12) Patent Application Publication
(10) Pub. No.: US 2016/0032612 A1
(43) Pub. Date: Feb. 4, 2016

(54) TENT PEG STRUCTURE WITH ILLUMINATION DEVICE

(71) Applicant: Chia-Ling HUANG, Taichung City (TW)

(72) Inventor: Chia-Ling HUANG, Taichung City (TW)

(21) Appl. No.: 14/449,433

(22) Filed: Aug. 1, 2014

(51) Int. Cl. E04H 15/10; F21V 33/00

(52) U.S. Cl. CPC E04H 15/10; F21V 33/008; F21Y 2101/02

(57) ABSTRACT

A tent peg with illumination device includes, a peg seat, a cord fixing part, an illumination device, and a resilient member. Therein, the peg seat has a peg bore in the middle for a peg body to pass through. The cord fixing part is disposed on one end of the peg seat for fastening a cord body. The illumination device has an installation seat and an illumination assembly. The installation seat is on the other end of the peg seat, and the illumination assembly is installed on the installation seat and capable of rotating against the installation seat for enabling the illumination assembly to illuminate. The resilient member is between the illumination assembly and the installation seat. During the rotation of the illumination assembly against the installation seat, the illumination assembly stably contacts an inner wall of the installation seat through the resilient member.

### BACKGROUND OF THE INVENTION

1. Field of the Invention

The present invention relates to tent peg structures, and more particularly, to a tent peg structure capable of illuminating for indicating the position of the tent peg and the tent cord fastened thereon.

2. Description of the Related Art

As shown by FIG. 1, most tents 200 are built by one or multiple clothes with several supporting rods. For stabilizing the tent 200 and protecting the tent 200 from effects of wind blowing and raining, cords 4 and tent pegs 1 are used for supporting, positioning, and fixing the tent 200. A conventional tent peg 1, as shown by FIG. 2, comprises a peg body 2 for being nailed into the ground and fixed, and the tent peg 1 further has a through hole 3 for the cord 4 to pass through. With the fixing force provided by the peg body 2 nailed into the ground, the cord 4 of the tent 200 is able to be fastened, thereby stably positioning the tent 200.

However, in an environment lack of illumination during activities of camping, campers easily kick the tent pegs 1 or trip over the cords 4 when walking by the tent 200. As a result, the tent 200 tends to topple over or campers possibly hurt. Therefore, such disadvantages are necessary to be resolved in the industry.

### SUMMARY OF THE INVENTION

For improving the aforementioned issues, the present invention discloses a tent peg structure with illumination device, which is able to illuminate for indicating positions of the tent peg and the cord body, thereby preventing campers from accidentally kicking the tent peg or tripping over the cord body.

For achieving the objective above, the present invention provides a tent peg structure with illumination device, comprising:

a peg seat, with a peg bore disposed in the middle for a peg body to pass through;

a cord fixing part, disposed on one end of the peg seat for fastening a cord body;

an illumination device, provided with an installation seat and an illumination assembly, wherein the installation seat is disposed on the other end of the peg seat, and the illumination assembly is disposed on the installation seat and capable of rotating against the installation seat for enabling the illumination assembly to illuminate; and

a resilient member, disposed between the illumination assembly and the installation seat, whereby, during the rotation of the illumination assembly against the installation seat, the illumination assembly stably contacts an inner wall of the installation seat by use of the resilient force provided by the resilient member.

Therein, a ring wall protrudes on the periphery of the peg bore, with a positioning groove disposed on a lateral side of the ring wall, while the installation seat is provided with a pivot part for being pivotally disposed in the positioning groove, whereby the illumination device is allowed to roll against the peg seat with the pivot part as the rolling pivot.

Therefore, when campers attend a camping activity, with the illumination provided by the illumination device, positions of the peg body and the cord body are identified, thereby preventing the campers from kicking the peg body or tripping over the cord body.

Furthermore, due to the capability of rolling against the peg seat with the pivot part as the rolling pivot, the illumination device is able to protrude or be folded from the positioning groove. Thus, the angle included by the illumination device and the positioning groove is allowed to be adjusted for meeting user and environmental demands, thereby adjusting the direction and the angle of the illumination. The convenience of usage is provided.

In addition, when the campers drive and position the peg bodies provided by the present invention into the ground, with the resilient force of the resilient member, the illumination device stably contacts the inner wall of the installation device, thereby preventing the illumination device from bouncing out of the installation device due to the impact force when the tent peg is being driving into the ground.

### BRIEF DESCRIPTION OF THE DRAWINGS

FIG. 1 is a schematic view illustrating a status of operation of a conventional tent.

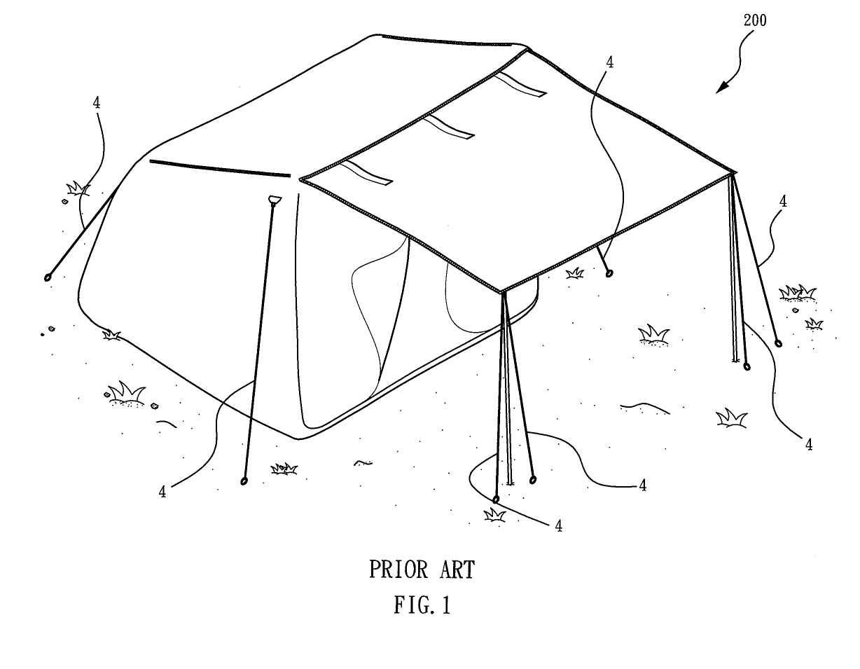

FIG. 2 is a perspective view of a known tent peg.

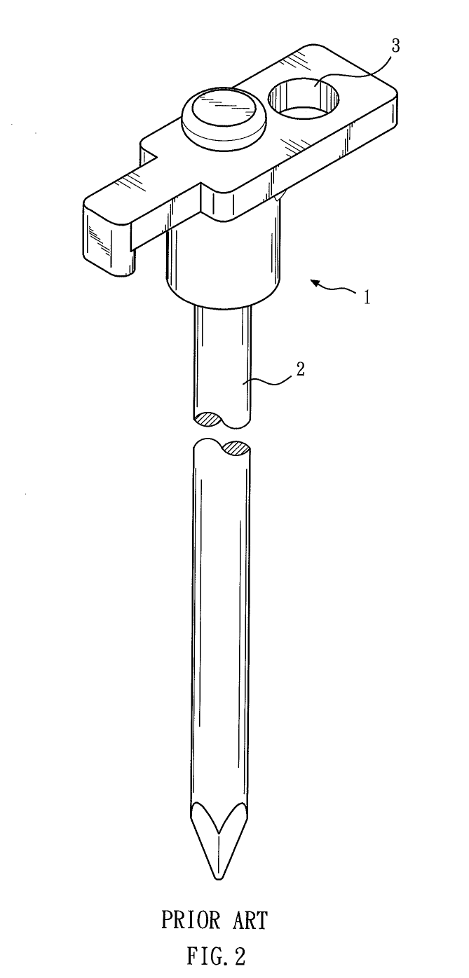

FIG. 3 is a perspective view of a tent peg structure in accordance with the present invention.

FIG. 4 is an exploded view of the tent peg structure in accordance with the present invention.

FIG. 5 is an exploded view of the illumination device in accordance with the present invention.

FIG. 6 is a schematic view illustrating the operation of the illumination device in accordance with the present invention.

FIG. 7 is another schematic view illustrating the operation of the illumination device in accordance with the present invention.

FIG. 8 is a schematic view illustrating the operation of the tent peg in accordance with the present invention.

FIG. 9 is a schematic view illustrating the adjustment of the angle of the illumination device in accordance with the present invention.

FIG. 10 is a schematic view illustrating the present invention in a status of being stored.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

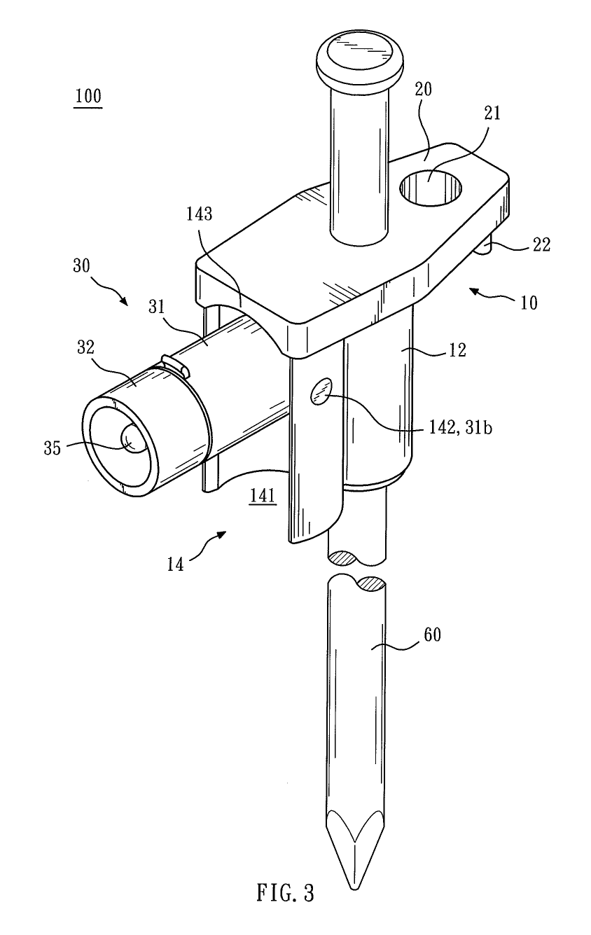

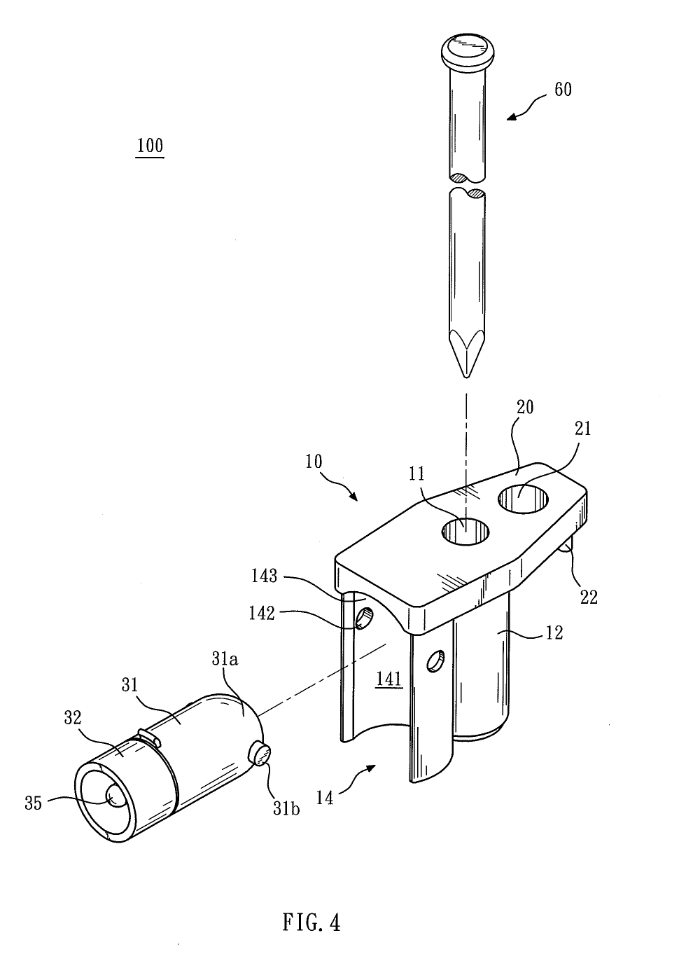

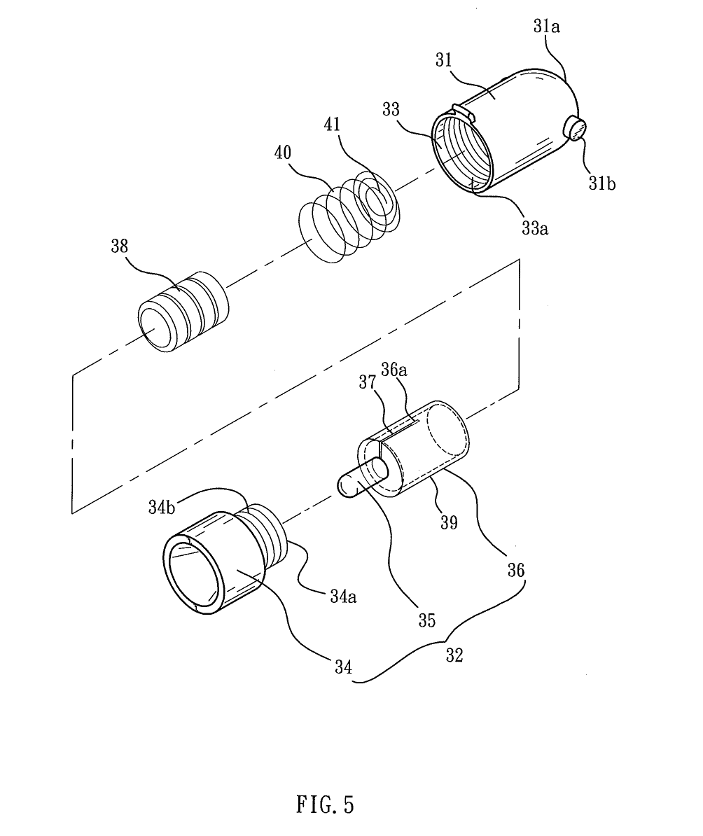

Referring to FIG. 3 to FIG. 6, the present invention provides a tent peg structure 100 with illumination device, comprising a peg seat 10, a cord fixing part 20, an illumination device 30, and a resilient member 40.

The peg seat 10 is provided with a peg bore 11 in the middle for a peg body 60 to pass through. A ring wall 12 protrudes on the periphery of the peg bore 11 for reinforcing the structural strength when the peg body 60 passes through the peg bore 11 to be combined with the peg seat 10. A positioning groove 14, structurally in a C shape in one embodiment of the present invention, is disposed on a lateral side of the ring wall 12, wherein one side of the positioning groove 14 opposite to the side adjacent to the ring wall 12 is provided with an open face 141, and a pair of axle bores 142 are transversely disposed on the wall of the positioning groove 14.

The cord fixing part 20 is disposed on one end of the peg seat 10 opposite to the end adjacent to the positioning groove 14, and provided with a through hole 21 for a cord body 50 to pass through and be fastened thereto. A fastening part 22 extends downward from one side of the through hole 21 away from the peg bore 11, so that when the cord body 50 passes through the through hole 21, the cord body 50 is allowed to be stably fastened by being contacting the fastening part 22.

The illumination device 30 comprises an installation seat 31 and an illumination assembly 32, wherein one end of the installation seat 31 has a pivot part 31a, and the other end is provided with an installation bore 33 for the illumination assembly 32 to be screwed thereto.

The pivot part 31a of the installation seat 31 has a pair of rotation axles 31b able to be disposed in the pair of axle bores 142, whereby the illumination device 30 is pivotally and rollably disposed in the positioning groove 14 through the installation seat 31. Also, the illumination device 30, with the pivot part 31a as the rolling pivot, is able to roll between a first illuminating axis, which is parallel to the peg body 60, and a second illuminating axis, which is perpendicular to the peg body 60, whereby the illumination device 30 is allowed to rollably protrude from the open face 141 of the positioning groove 14 or be folded and stored in the positioning groove 14. An allowance part 143 is disposed on one end of the bottom surface of the peg seat 10 adjacent to the positioning groove 14, whereby the maximum rolling angle of the illumination device 30 is increased when the illumination device 30 is rolling.

The illumination assembly 32 comprises a cover 34, an LED illuminant 35, and a battery assembly 36. Therein, the cover 34 is provided with a fixing part 34a having an outer thread 34b for matching an inner thread 33a disposed in the installation bore 33, whereby the cover 34 is screwed in the installation bore 33 through the fixing part 34a. The battery assembly 36 is formed by a battery member 38 and a casing 39 mounting around the battery member 38. The LED illuminant 35 is coupled with one end of the casing 39 and at the same time electrically connected to the battery member 38. One end of the LED illuminant 35 is electrically connected to an electrode wire 37, which is disposed along a containing groove 36a surrounding the battery assembly 36. One end of the casing 39 is fixed to the fixing part 34a of the cover 34, whereby the LED illuminant 35 passes through the cover 34, while the other end of the casing 39 is placed inside the installation seat 31.

The resilient member 40 is made of a conductive metal and mounts around one end of the casing 39 of the battery assembly 36 opposite to the end adjacent to the fixing part 34a, whereby the resilient member 40 is disposed between the illumination assembly 32 and the installation seat 31, with one end of the resilient member 40 connected to the electrode wire 37 and the other end having a resilient face 41 contacting the bottom of the installation seat 31. Also, the vertical length of the resilient member 40 is larger than the length of the battery assembly 36, whereby a resilient buffer portion is provided between the battery assembly 36 and the installation seat 31.

With the foregoing configuration, operation of the present invention will be illustrated below.

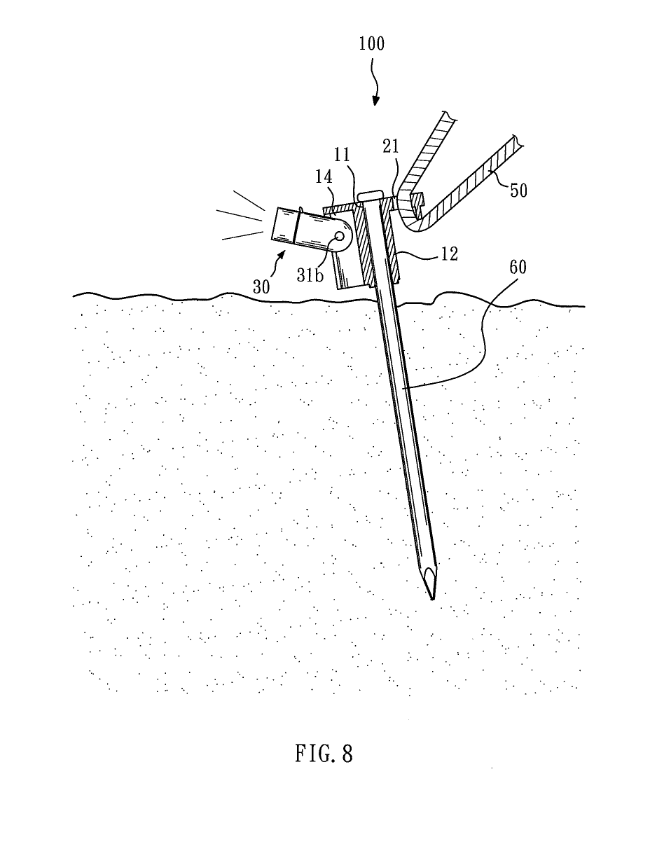

The peg seat 10 of the present invention is nailed into the ground by use of the peg body 60, as shown by FIG. 8. The through hole 21 on the cord fixing part 20 is disposed for the cord body 50 to pass through when a tent is being built, whereby the cord body 50 is pulled, supported, and fixed for facilitating the tent building work.

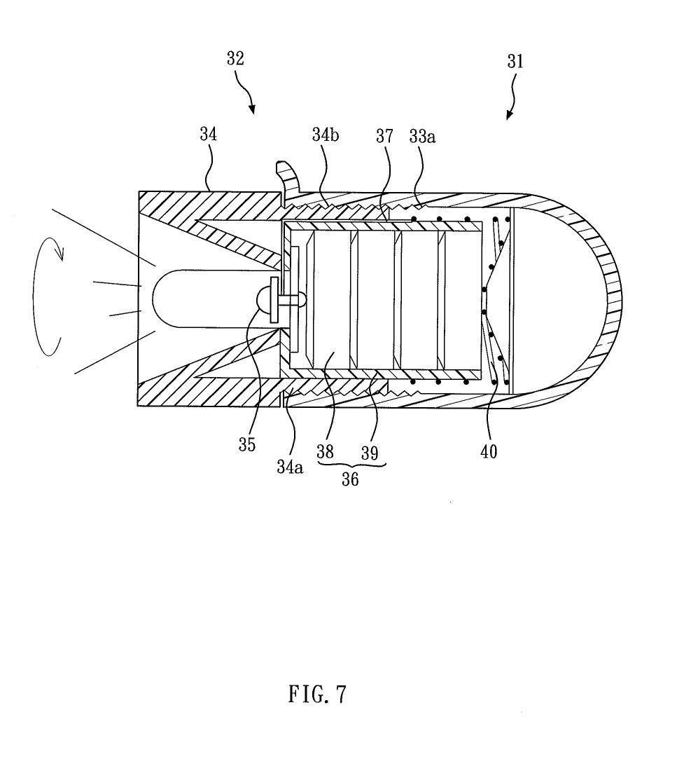

When the illumination assembly 32 is rotated against the installation seat 31 and toward the bottom of the installation seat 31, the battery assembly 36 moves toward the bottom of the installation seat 31, whereby the resilient member 40 is compressed, causing the other end of the resilient member 40 to contact the battery member 38, as shown by FIG. 7. At the meantime, the electrode wire 37 and the resilient member 40 are electrically connected, whereby the positive electrode and the negative electrode of the battery member 38 are connected with each other, enabling the LED illuminant 35 of the illumination assembly 32 to emit light for illumination.

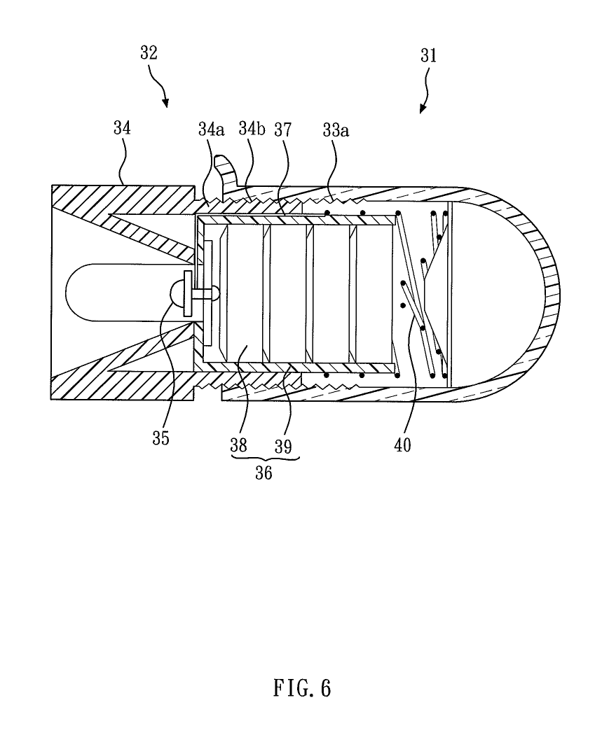

On the other hand, when the illumination provided by the illumination assembly 32 is not needed, the illumination assembly 32 is rotated against the installation seat 31 and toward the direction away from the bottom of the installation seat 31, whereby the battery assembly 36 moves away from the bottom of the installation seat 31, and the other end of the resilient member 40 is prevented from contacting the battery member 38, as shown by FIG. 6. The positive and negative electrodes of the battery member 38 are not connected with each other; therefore, the LED illuminant 35 of the illumination assembly 32 is kept from being switched-on.

When the light source is insufficient during camping activities, the illumination assembly 32 of the present invention is switched-on for providing illumination, wherein positions of the peg body 60 and the cord body 50 are allowed to be identified for preventing the campers from accidentally kicking the peg body 60 or tripping over the cord body 50. Therefore, the present invention is able to actually resolve the issues of the tent toppling over or the campers wounded by accidentally kicking the tent pegs.

Furthermore, when the peg body 60 of the present invention is driven by the camper and nailed into the ground for being fixed and positioned, through the resilient force of the resilient member 40, the illumination assembly 32 stably contacts the inner wall of the installation seat 31, whereby the illumination assembly 32 is prevented from bouncing out of the installation seat 31 due to the effect of the impact force produced by the peg body 60 being driven. Also, a resilient buffer portion is disposed between the battery assembly 36 and the installation seat 31, thereby preventing the installation seat 31 and the battery assembly 36 from being worn out by each other.

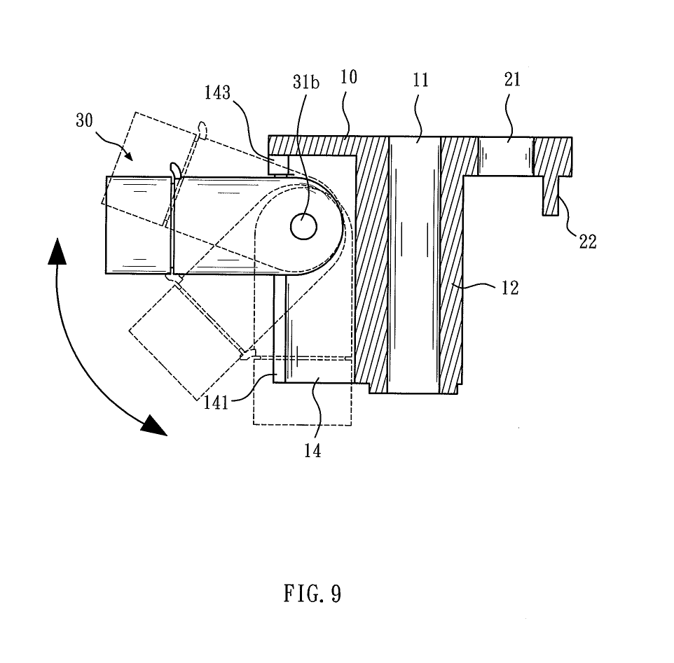

In addition, referring to FIG. 9, through the cooperation between the axle bores 142 and the rotation axles 31b, when the illumination device 30 protrudes out of the positioning groove 14 from the open face 141, the angle included by the illumination device 30 and the positioning groove 14 is able to vary. Therefore, based on different user and environmental demands, the illuminating direction and angle of the illumination device 30 of the present invention are allowed to be adjusted. Also, when the illumination device 30 rolls against the peg seat 10, the allowance part 143 increases the maximum rolling angle of the illumination device 30. For example, when the allowance part 143 is not provided, the maximum rolling angle of the illumination device 30 is about 90 degrees. In contrast, when the allowance part 143 is provided, the maximum rolling angle of the illumination device 30 is increased to at least 105 degrees.

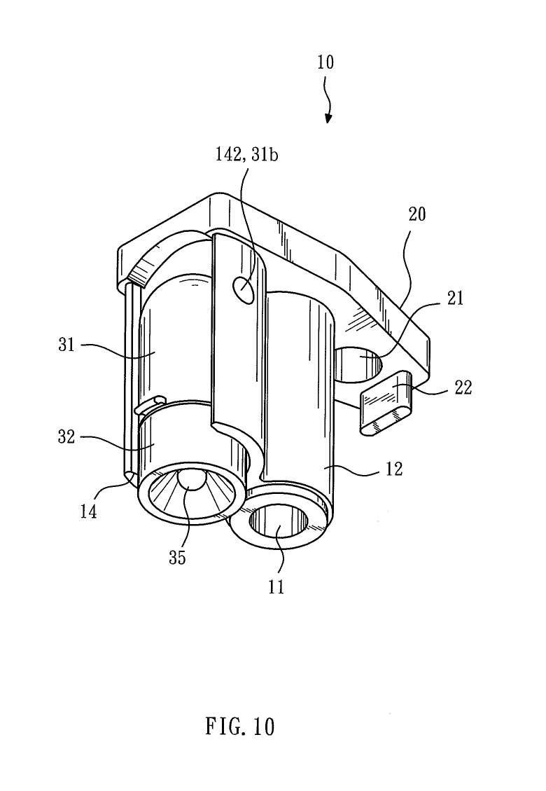

Furthermore, referring to FIG. 10, the illumination device 30 is allowed to be folded in the positioning groove 14 for decreasing the general volume of the present invention, facilitating the storing and transporting, and preventing the illumination device 30 from being accidentally damaged. With the positioning groove 14 structurally in a C shape, when the illumination device 30 is folded in the positioning groove 14, the lateral wall of the open face 141 provides a resilient fixing force for preventing the illumination device 30 from being accidentally detached from the positioning groove 14.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tent peg with illumination device, comprising:
a peg seat, with a peg bore disposed in the middle for a peg body to pass through;
a cord fixing part, disposed on one end of the peg seat for fastening a cord body;
an illumination device, provided with an installation seat and an illumination assembly, wherein the installation seat is disposed on the other end of the peg seat, and the illumination assembly is disposed on the installation seat and capable of rotating against the installation seat for enabling the illumination assembly to illuminate; and
a resilient member, disposed between the illumination assembly and the installation seat, whereby, during the rotation of the illumination assembly against the installation seat, the illumination assembly stably contacts an inner wall of the installation seat by use of the resilient force provided by the resilient member.

2. The tent peg of claim 1, wherein one end of the installation seat is provided with a pivot part for being pivotally disposed on the peg seat, whereby the illumination device is allowed to roll against the peg seat with the pivot part as the rolling pivot.

3. The tent peg of claim 1, wherein a ring wall protrudes on the periphery of the peg bore, with a positioning groove disposed on a lateral side of the ring wall, while one end of the installation seat is provided with a pivot part for being pivotally disposed in the positioning groove.

4. The tent peg of claim 3, wherein a pair of axle bores are transversely disposed on the wall of the positioning groove, and the pivot part is provided with a pair of rotation axles capable of being disposed in the pair of axle bores, whereby the illumination device is pivotally and rollably disposed in the positioning groove.

5. The tent peg of claim 2, wherein the illumination device, with the pivot part as the rolling pivot, is able to roll against the peg seat between a first illuminating axis, which is parallel to the peg body, and a second illuminating axis, which is perpendicular to the peg body.

6. The tent peg of claim 2, wherein one end of the installation seat opposite to an end provided with the pivot part is provided with an installation bore for the illumination assembly to be screwed thereto.

7. The tent peg of claim 2, wherein the illumination assembly comprises a cover, an LED illuminant, and a battery assembly, while the cover has a fixing part, the LED illuminant is electrically connected to the battery assembly, and one end of the battery assembly is fixed to the fixing part, whereby the LED illuminant passes through the cover, and the other end of the battery assembly is placed inside the installation seat.

8. The tent peg of claim 7, wherein one end of the LED illuminant is electrically connected to an electrode wire surrounding the battery assembly, while the resilient member mounts around one end of the battery assembly opposite to the end adjacent to the fixing part, with one end of the resilient member connected to the electrode wire and the other end of the resilient member having a resilient face contacting the bottom of the installation seat.

9. The tent peg of claim 8, wherein the vertical length of the resilient member is larger than the length of the battery assembly, whereby a resilient buffer portion is provided between the battery assembly and the installation seat.

10. The tent peg of claim 8, wherein the resilient member is made of a conductive metal.

11. The tent peg of claim 7, wherein the fixing part is provided with an outer thread, and one end of the installation seat opposite to the end provided with the pivot part is provided with an installation bore, while an inner thread for matching the outer thread is disposed in the installation bore.

12. The tent peg of claim 3, wherein an allowance space is disposed on the bottom surface of the peg seat adjacent to the positioning groove.

13. The tent peg of claim 3, wherein the positioning groove is structurally in a C shape.

14. The tent peg of claim 1, wherein the cord fixing part is provided with a through hole for a cord body to pass through and be fastened thereto, and a fastening part extends downward from one side of the through hole away from the peg bore.
